(19) United States
(12) Patent Application Publication
(10) Pub. No.: US 2023/0173574 A1
(43) Pub. Date: Jun. 8, 2023

(54) MULTIFUNCTIONAL TOOL

(71) Applicant: Arthur Rico Mora, Tehachapi, CA (US)

(72) Inventor: Arthur Rico Mora, Tehachapi, CA (US)

(21) Appl. No.: 18/074,285

(22) Filed: Dec. 2, 2022

Related U.S. Application Data
(60) Provisional application No. 63/285,881, filed on Dec. 3, 2021.

(51) Int. Cl. B21J 15/50; B25C 11/00; B25C 9/00; B25D 3/00; B66F 15/00

(52) U.S. Cl. CPC B21J 15/50; B25C 9/00; B25C 11/00; B25D 3/00; B66F 15/00

(57) ABSTRACT

A multifunctional tool which may be used for rivet removal, as well as other applications includes a prybar member coupled to a punch member, wherein the prybar creates a handle that holds the punch enabling the user to distance the punch from his/ her hand when striking the punch with a hammer. In certain embodiments, the tool further comprises at least one nail pull slot at the claw of the prybar element. In some embodiments, the tool also provides a chisel end, which may be used by striking the handle at an end opposite the chisel end.

### RELATED APPLICATION

This application claims priority to Provisional Pat. Application U.S. Serial No. 63/285,881 filed on Dec. 3, 2021, the entire contents of which is herein incorporated by reference.

### BACKGROUND

The present disclosure relates generally to multipurpose tools, and more specifically to a tool useful in rivet removal.

Rivet removal may typically require multiple tools such as a punch, hammer, and a chisel. For example, a typical process for removal of a rivet from a sign may involve striking the punch with the hammer to loosen the center part of the rivet and driving the chisel between the rivet and the sign with a hammer for the final removal step. This process risks injury to the hand, in addition to requiring multiple tools. As such, there is a need for an improved system that addresses at least the above-mentioned limitation of the prior art.

### SUMMARY

According to various embodiments, disclosed is a multifunctional tool which may be used for rivet removal, as well as other applications.

In certain embodiments, the multifunctional tool may comprise a prybar member comprising a shaft and a claw extending from a bottom end of the shaft; at least one nail pull slot within the claw of the prybar member; and a nail punch coupled to the shaft, wherein a longitudinal axis of the nail punch is at an approximate right angle to a longitudinal axis of the shaft. Thus, the prybar member creates a handle that holds the punch instead of the user having to hold the punch in his hand. This enables the user to distance the punch from his hand when striking the punch with a hammer.

In some embodiments, wherein the nail punch is coupled proximate a top end of the shaft opposite the bottom end. In further embodiments, the nail pull slot includes an intermediate slot disposed within the claw proximate the top end of the shaft. In some embodiments, the intermediate slot includes a front-side opening and a rear-side opening, wherein the front-side opening extends from a front side of the claw to an intermediate section along the width of the claw, wherein the rear-side opening is stepped inwards from the front-side opening and extends from the intermediate section to a rear-side of the claw along the width of claw, and wherein the front-side opening is larger than the rear-side opening such that the intermediate section creates a platform for engagement of a fastener head. In further embodiments, the front-side opening is stadium shaped, wherein rear-side opening is teardrop shaped with its narrow end pointed towards a bottom edge of the claw.

In some embodiments, the bottom edge of the claw is a chisel edge. In certain embodiments, the nail pull slot includes an edge slot within the chisel edge of the claw. In some embodiments, the edge slot is a beveled triangular opening, which progressively narrows from a front side of the claw to a rear side of the claw. In some embodiments, the edge slot and/or bottom edge are specifically configured to accommodate a specific type of rivet. In certain embodiments, the nail punch is coupled to a rear side of the shaft. In further embodiments, the nail pull slot includes an intermediate slot proximate the bottom end of the shaft, the intermediate slot including a teardrop shape with a narrow end, wherein a narrow end of the edge slot points to the narrow end of the intermediate slot.

### BRIEF DESCRIPTION OF THE FIGURES

The detailed description of some embodiments of the invention will be made below with reference to the accompanying figures, wherein the figures disclose one or more embodiments of the present invention.

FIG. 1 is a front perspective view of a multifunctional tool according to various embodiments.

FIG. 2 is a rear perspective view of the multifunctional tool.

FIG. 3 is a side elevation view of the multifunctional tool in use as a prybar.

FIG. 4 is a perspective view of the multifunctional tool in use as a pin or nail punch.

FIG. 5 is a perspective view of the multifunctional tool in accordance with an alternate embodiment.

### DETAILED DESCRIPTION OF CERTAIN EMBODIMENTS

Disclosed is a multifunctional tool 10, which may be used for rivet removal as well as other applications. In some embodiments, multifunctional tool 10 may provide a combination punch, chisel, prybar tool, which may be ideal for use in removal of a street sign 15 or other object as will be described.

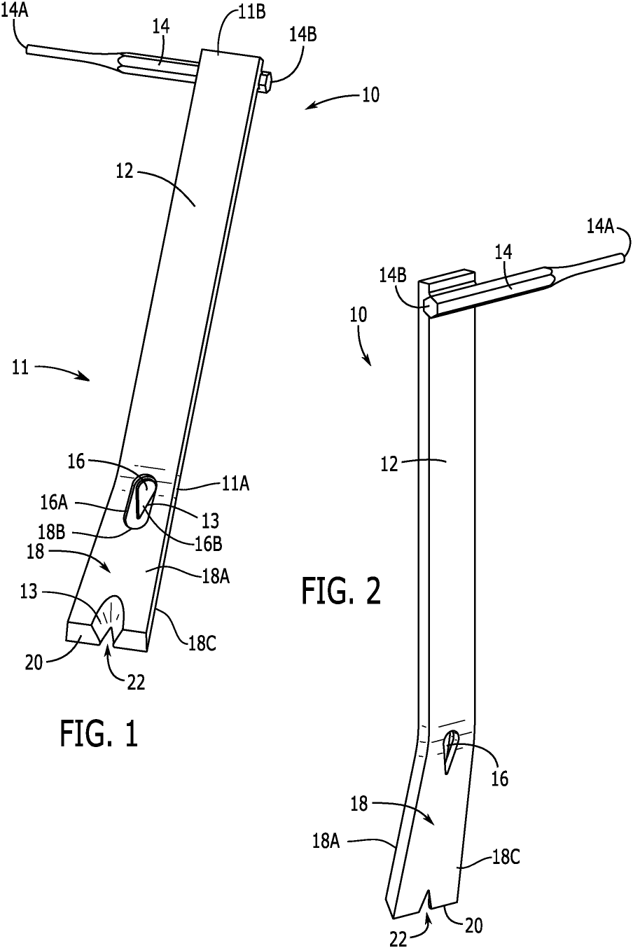

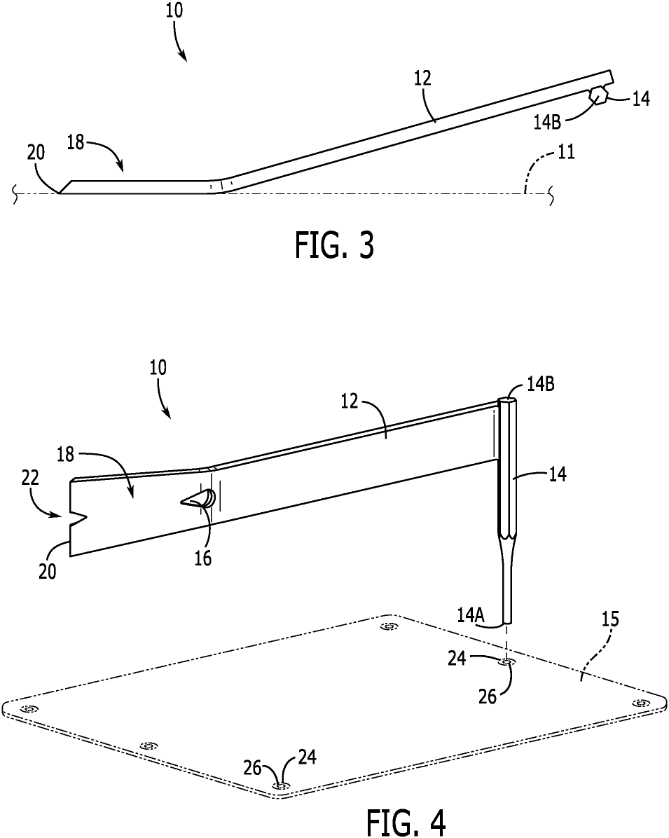

According to various embodiments as depicted in FIGS. 1-4, multifunctional tool 10 may generally comprise a prybar member 11 coupled to a punch member 14. In further embodiment, the prybar member 11 may incorporate at least one nail pull slot 13.

According to various embodiments, prybar member 11 comprises a shaft 12 and a claw 18 extending from a bottom end 11A of shaft 12. Shaft 12 is generally significantly longer than claw 18 and provides a leveraged handle for using claw 18. In one embodiment, prybar member 18 may be a tempered steel prybar. In some embodiments as depicted in FIGS. 1-4, claw 18 may be obtusely angled with respect to shaft 12 and may include a chisel end 20. It shall be appreciated that different prybar configurations, including various alignment, shapes, and sizes of the claw and shaft as known in the art may be used in alternate embodiments.

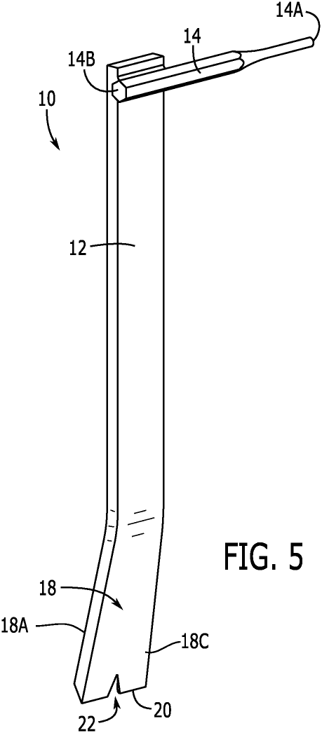

In certain embodiments, nail pull slot 13 may include an intermediate slot 16 within the claw of prybar 11. In further embodiments, nail pull slot 13 may comprise an edge slot 22. In one embodiment, intermediate slot 16 may be disposed proximate top end 11A of shaft 12, while edge slot 22 may be provided on a bottom or chisel edge 20 of claw 18. In some embodiments, multifunctional tool 10 may comprise only edge slot 22, without intermediate slot 16 (see FIG. 5).

In some embodiments, intermediate slot 16 may comprise a front-side opening 16A which extends from a front side 18A of claw 18 to an intermediate section 18B along the width of claw 18. Intermediate slot 16 may further comprise a rear-side opening 16B which is stepped inwards from front opening 16A and extends from intermediate section 18B to a rear-side 18C along the width of claw 18 such that the intermediate section creates a platform for engagement of a fastener head, such as a nail head or rivet head. In one embodiment, front opening 16A may be stadium shaped, while rear opening 16B may be teardrop shaped with its narrow end pointed towards the chisel edge 20, wherein front opening 16A is larger than rear opening 16B. In certain embodiments, edge slot 22 may be a beveled triangular opening, which progressively narrows from front side 18A to rear side 18C of claw 18. In further embodiments, edge slot 22 and/or chisel edge 20 may be specifically shaped and/or sized to accommodate a specific type of rivet. In some embodiments, the narrow ends intermediate slot 16 and edge slot 22 point towards one another, as shown. As such, intermediate slot 16 and/or edge slot 22 provide a versatile nail/rivet removal system, which enables a user to easily remove nails of different sizes and positions with the mechanical advantage of a wedge and/or lever. In an alternate embodiment, multifunctional tool may omit intermediate slot 16, wherein chisel edge 20 incorporating edge slot may be specifically configured to accommodate a rivet of a specific shape and size.

In certain embodiments, punch member 14 (also referred to as nail punch or pin punch) may be attached, e.g., welded, to shaft 12 of prybar 11 proximate a top end 11B opposite bottom end 11A of prybar member 11. In certain embodiments, nail punch 14 may be attached with its longitudinal axis at an approximate right angle to the longitudinal shaft axis of prybar member 11. In some embodiments, nail punch may be attached to the rear side of prybar member 11, but not necessarily so. In certain embodiments, nail punch 14 may comprise a flat punch tip 14A opposite a striking end 14B of the nail punch, wherein both flat punch tip 14A and striking end 14B extend past the side edges of shaft 12. In one embodiment, punch member 14 may comprise a tempered steel punch. As such, shaft 12 of prybar member 18 creates a handle that holds nail punch 14 instead of the user having to hold the nail punch in his hand. Additionally, shaft 12 enables the user to distance nail punch 14 from his hand when striking the punch with a hammer, thus eliminating the chance of accidentally striking and injuring the hand when hammering the punch.

In embodiments, multifunctional tool 10 may be used to remove a rivet from a street sign 15 or another object. A user may position flat punch tip 14A at the center of the rivet and strike end 14B of nail punch 14 with a hammer to release the rivet from pressure. The user may then engage the rivet within the intermediate slot 16 or edge slot 22 within the prybar claw, to pry the rivet off the sign. In one embodiment, the user may engage the rivet within the edge slot 22 and hammer the tool from the opposite end to enable the edge slot to get under the rivet and to dislodge it. As such, multifunctional tool 10 reduces the number of individual tools which need to be used for rivet removal and makes rivet removal and other tasks that require the use of chisels and punches safer and more convenient.

It shall be appreciated that multifunctional tool 10 can have multiple configurations in different embodiments. For example, in certain embodiments, multifunctional tool 10 may have a slide hammer configuration. It shall be appreciated that the components of multifunctional tool 10 described herein may comprise any alternative known materials in the field and be of any size and/or dimensions. It shall be appreciated that components of multifunctional tool 10 may be manufactured and assembled using any known techniques in the field.

As used herein, the articles “a” and “an” are intended to include one or more items and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/-10%. Relationships between the various elements of the disclosed device as described herein are presented as illustrative examples only, and not intended to limit the scope or nature of the relationships between the various elements. Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A multifunctional tool, comprising:
a prybar member comprising a shaft and a claw extending from a bottom end of the shaft;
at least one nail pull slot within the claw of the prybar member; and
a nail punch coupled to the shaft
wherein a longitudinal axis of the nail punch is at an approximate right angle to a longitudinal axis of the shaft.

2. The multifunctional tool of claim 1, wherein the nail punch is coupled proximate a top end of the shaft opposite the bottom end.

3. The multifunctional tool of claim 1, wherein the nail pull slot includes an intermediate slot disposed within the claw proximate the top end of the shaft.

4. The multifunctional tool of claim 3, wherein the intermediate slot includes a front-side opening and a rear-side opening, wherein the front-side opening extends from a front side of the claw to an intermediate section along the width of the claw, wherein the rear-side opening is stepped inwards from the front-side opening and extends from the intermediate section to a rear-side of the claw along the width of claw, and wherein the front-side opening is larger than the rear-side opening such that the intermediate section creates a platform for engagement of a fastener head.

5. The multifunctional tool of claim 4, wherein the front-side opening is stadium shaped, wherein rear-side opening is teardrop shaped with its narrow end pointed towards a bottom edge of the claw.

6. The multifunctional tool of claim 1, wherein the bottom edge of the claw is a chisel edge.

7. The multifunctional tool of claim 6, wherein the nail pull slot includes an edge slot within the chisel edge of the claw.

8. The multifunctional tool of claim 7, wherein the edge slot is a beveled triangular opening, which progressively narrows from a front side of the claw to a rear side of the claw.

9. The multifunctional tool of claim 8, wherein the edge slot and/or bottom edge are specifically configured to accommodate a specific type of rivet.

10. The multifunctional tool of claim 8, wherein the nail punch is coupled to a rear side of the shaft.

11. The multifunctional tool of claim 10, wherein the nail pull slot further includes an intermediate slot proximate the bottom end of the shaft, the intermediate slot including a teardrop shape with a narrow end, wherein a narrow end of the edge slot points to the narrow end of the intermediate slot.
